(19) United States
(12) Patent Application Publication
(10) Pub. No.: US 2015/0030369 A1
(43) Pub. Date: Jan. 29, 2015

(54) MECHANICAL PENCIL HAVING LEAD-ROTATING MECHANISM

(71) Applicant: Micro Co., Ltd., Tokyo (JP)

(72) Inventor: Tomohiro HOSOYA, Fukushima-ken (JP)

(73) Assignee: Micro Co., Ltd., Tokyo (JP)

(21) Appl. No.: 14/140,611

(22) Filed: Dec. 26, 2013

(30) Foreign Application Priority Data
Jul. 25, 2013 (JP) 2013-154154

(51) Int. Cl. B43K 21/16

(52) U.S. Cl. CPC B43K 21/16
USPC 401/65

(57) ABSTRACT

A mechanical pencil has a main body inserted into a tubular main body cover to undergo forward and rearward movement and rotational movement within the main body cover. The main body feeds a lead and holds the lead during writing. A gear mechanism incrementally rotates the main body based on the presence or absence of writing pressure occurring during writing to thereby incrementally rotate the lead. Protection collars are rotatably mounted on the outer periphery of the main body at locations where the main body is exposed from the main body cover. The protection collars rotatably idle on the main body to prevent a person from gripping and rotating the main body thereby preventing damage to the gear mechanism.

### BACKGROUND OF THE INVENTION

1. Field of the Invention

The present invention relates to a lead-rotatable mechanical pencil in which the front end of a lead worn away by writing can be recovered to a pointed condition by incrementally rotating the lead during the course of writing.

2. Background Information

When the front end of a lead is worn away by writing, the line becomes thicker, and therefore there has been known a mechanical pencil having a lead-rotating mechanism in which a pointed lead condition can be recovered by rotating the lead. As the lead-rotating mechanism, various structures have been proposed. One such structure is a mechanism in which a lead is automatically rotated by utilizing writing pressure.

For example, in a mechanism described in Japanese Patent No. 4240417, a chuck unit for gripping and releasing a lead is rotatably held in a barrel, a rotation-driving mechanism drives a rotator to rotate along the retraction motion of the chuck unit by writing pressure, and the rotation motion of the rotator is transferred to the lead via the chuck unit to rotate the lead. However, in order to manufacture a mechanical pencil incorporating this mechanism, it is necessary to change the chuck unit mechanism itself from that used in conventionally known knocking-type mechanical pencils, and therefore the structures become complicated, the production is cumbersome, and such pencils cannot be obtained at low costs.

As another example, Japanese Patent No. 5193176 discloses a mechanism in which a mechanical pencil main body is rotated as a whole by which a lead can be rotated without changing or modifying the chuck unit that grips and releases the lead. This mechanical pencil is designed so that a mechanical pencil main body having a conventional, commonly used lead-feeding mechanism, such as a knocking-type mechanical pencil or a rotating-type mechanical pencil, is rotatably housed in a main body cover, and writing pressure intermittently applied during writing effects forward and backward motions of the mechanical pencil main body within the main body cover to rotate the mechanical pencil main body by which the lead is rotated. By using this mechanical pencil structure, a mechanical pencil main body having a usual lead-feeding mechanism can be used, and thus the structures become simple and can be obtained at low costs.

In Japanese Patent No. 5193176, the basic structure to rotate the mechanical pencil main body has a gear mechanism having a front gear and a rear gear provided in the main body cover, and a forward fixed gear and a rearward fixed gear provided on the outer periphery of the mechanical pencil main body. The main body cover and the mechanical pencil main body are urged by a writing pressure spring so that when no writing pressure is applied, the mechanical pencil main body advances by which the rear gear and the rearward fixed gear are meshed, and when writing pressure is applied, the pencil main body retracts by which the front gear and the forward fixed gear are meshed. The phase of the teeth of the front gear and the forward fixed gear and the phase of the teeth of the rear gear and the rearward fixed gear are shifted (out-of-phase) relative to one another. By this structure, the mechanical pencil main body rotates upon forward and backward motions. Since the rear gear and the rearward fixed gear are meshed under non-writing conditions in the mechanical pencil main body, if a person tries to forcibly rotate the part of the mechanical pencil main body that protrudes from the main body cover while gripping the main body cover, the gear mechanism parts are likely to be damaged.

The writing pressure spring that urges the mechanical pencil main body is installed between the main body cover and the forward fixed gear provided on the mechanical pencil main body. Namely, one end of the writing pressure spring abuts on the forward fixed gear provided on the pencil main body as a rotating part, and another end abuts on the main body cover as a fixed part. Accordingly, when the mechanical pencil main body rotates, the writing pressure spring rotates together with the forward fixed gear, frictional resistance is produced between one end of the writing pressure spring and the main body cover, whereby the mechanical pencil main body is not smoothly rotated and the lead may fail to securely rotate.

### SUMMARY OF THE INVENTION

An object of the present invention is to provide a mechanical pencil having a lead-rotating mechanism that overcomes the aforementioned drawbacks of the prior art.

Another object of the present invention is to provide a mechanical pencil having a lead-rotating mechanism that incrementally rotates a lead utilizing writing pressure intermittently applied during writing.

A further object of the present invention is to provide a mechanical pencil having a mechanical pencil main body housed in a main body cover to undergo rotational movement and axial forward-and-rearward movement in the main body cover, and having a gear mechanism that incrementally rotates a lead in response to forward and rearward movement of the mechanical pencil main body caused by writing pressure intermittently applied during writing.

A further object of the present invention is to provide a mechanical pencil having a mechanical pencil main body slidably and rotatably housed in a main body cover to undergo forward-and-backward movement and rotational movement to securely incrementally rotate a lead when the mechanical pencil main body moves forward and rearward.

Another object of the present invention is to provide a mechanical pencil in which a mechanical pencil main body is rotated in a main body cover by writing pressure to rotate a lead and in which a gear mechanism that rotates the mechanical pencil main body will not be damaged by forcibly rotating the mechanical pencil main body when the mechanical pencil is not in use.

The foregoing and other objects of the present invention are realized by a mechanical pencil having a tubular main body cover and a mechanical pencil main body slidably and rotatably housed in the main body cover to undergo forward-and-backward movement and rotational movement to feed a lead from the front end of a barrel. On the inner face of the main body cover, a front gear having teeth facing forward and a rear gear having teeth facing backward are formed. On an outer periphery of the mechanical pencil main body, a forward fixed gear having teeth that mesh with the front gear and a rearward fixed gear having teeth that mesh with the rear gear are provided. A writing pressure spring urges the mechanical pencil main body so that when writing pressure is applied, it allows the mechanical pencil main body to axially retract and when the writing pressure is eliminated, the mechanical pencil main body is moved axially forward to mesh the rear gear and the rearward fixed gear. The phase of the teeth of the front gear and the forward fixed gear and the phase of the teeth of the rear gear and the rearward fixed gear are shifted (out-of-phase) so that the mechanical pencil main body incrementally rotates when the mechanical pencil main body moves forward and backward. On the outer periphery of the mechanical pencil main body that is exposed from the main body cover, rotatable protection collars are provided so that the mechanical pencil main body cannot be rotated by application of an external force.

The protection collars preferably comprise a tapered collar provided at the front end side of the mechanical pencil main body and a main body collar provided at the rear end side of the mechanical pencil main body. The writing pressure spring is disposed between the main body cover and the forward fixed gear. One end of the writing pressure spring is supported by the main body cover or the forward fixed gear via a rotatable slide ring. Further, the main body cover is preferably provided with a window through which the rotation condition of the mechanical pencil main body can be seen from the outside.

In the mechanical pencil of the present invention constructed as above, when the writing pressure is applied during use, the mechanical pencil main body axially retracts in the main body cover, and when the writing is stopped, the writing pressure is no longer applied and the mechanical pencil main body axially advances. During the forward and rearward motions, the mechanical pencil main body incrementally rotates by which the lead is rotated. Further, even if a person tries to grip the mechanical pencil main body exposed from the main body cover and rotate it, since the exposed portion is covered with a rotatable protection collar, the protection cover idles and therefore the mechanical pencil main body is not rotated. Accordingly, it is possible to avoid damage to the rear gear and the rearward fixed gear which are in meshing engagement during nonuse of the mechanical pencil.

Also, when one end of the writing pressure spring is supported by the main body cover or the forward fixed gear via a rotatable slide ring, the frictional resistance generated at the end portion of the writing pressure spring can be reduced due to rotation of the slide ring, whereby the mechanical pencil main body rotates smoothly and the lead can be rotated securely.

Additional objects, advantages and features of the present invention are set forth in the following description and others will become apparent to those skilled in the art upon examination of the following or may be learned by practice of the invention.

### BRIEF DESCRIPTION OF THE DRAWINGS

FIG. 1 is a cross-sectional view showing one embodiment of a mechanical pencil according to the present invention.

FIGS. 2A-2E show a barrel of a mechanical pencil main body, wherein FIG. 2A is a front view thereof, FIG. 2B is a cross-sectional view thereof, FIG. 2C is a cross-sectional view thereof taken along line C-C in FIG. 2A, FIG. 2D is a cross-sectional view thereof taken along line D-D in FIG. 2A, and FIG. 2E is a cross-sectional view thereof taken along line E-E in FIG. 2A.

FIGS. 3A-3B show a tapered member, wherein FIG. 3A is a plan view thereof, and FIG. 3B is a cross-sectional view thereof.

FIGS. 4A-4B show a main body cover, wherein FIG. 4A is a plan view thereof, and FIG. 4B is a cross-sectional view thereof.

FIGS. 5A-5E show a forward fixed gear, wherein FIG. 5A is a plan view thereof, FIG. 5B is a left-side elevational view thereof, FIG. 5C is a right-side elevational view thereof, FIG. 5D is a cross-sectional view thereof taken along an engagement hole, and FIG. 5E is a cross-sectional view thereof taken along a rotation-preventing rib.

FIGS. 6A-6D show a rearward fixed gear, wherein FIG. 6A is a plan view thereof, FIG. 6B is a left-side elevational view thereof, FIG. 6C is a right-side elevational view thereof, and FIG. 6D is a cross-sectional view thereof.

FIGS. 7A-7D show a slide ring, wherein FIG. 7A is a plan view thereof, FIG. 7B is a left-side elevational view thereof, FIG. 7C is a right-side elevational view thereof, and FIG. 7D is a cross-sectional view thereof.

FIGS. 8A-8B show a tapered collar, wherein FIG. 8A is a plan view thereof, and FIG. 8B is a cross-sectional view thereof.

FIGS. 9A-9B show a main body collar, wherein FIG. 9A is a plan view thereof, and FIG. 9B is a cross-sectional view thereof.

FIG. 10 is an explanatory view showing a gear part to which no writing pressure is applied.

FIG. 11 is an explanatory view showing a gear part to which writing pressure is applied.

FIGS. 12A-12B show another example of a window, wherein FIG. 12A is a plan view thereof, and FIG. 12B is a front view thereof.

FIG. 13 shows a front view, partially cut away, of another embodiment of a mechanical pencil according to the present invention.

FIG. 14 shows a front view, partially cut away, of a further embodiment of a mechanical pencil according to the present invention.

### DETAILED DESCRIPTION OF THE INVENTION

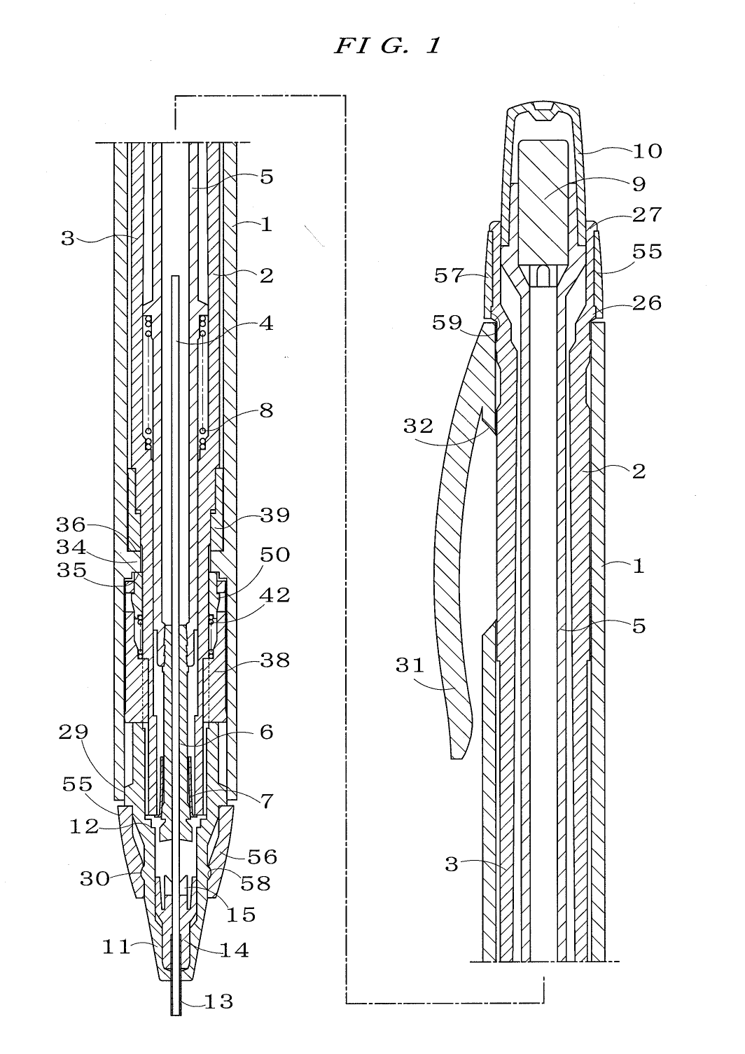

FIG. 1 shows one embodiment of a mechanical pencil according to the present invention. The mechanical pencil is constituted by a tubular main body cover 1 and a mechanical pencil main body 2 (sometimes referred to hereinafter as simply “main body”) rotatably housed in the main body cover 1 so as to be axially movable in forward and rearward axial directions. As the mechanical pencil main body 2, various types of mechanical pencils in which a lead is fed from the front end of a barrel may be used as the mechanical pencil main body. For example, a rotation feeding-type mechanical pencil may be used as the pencil main body. In the example shown in this figure, a so-called knocking-type mechanical pencil is used as the mechanical pencil main body.

The mechanical pencil main body 2 as shown in this example has basically the same structure as that of well-known knocking-type mechanical pencils. Briefly explaining, the main body 2 comprises a barrel 3 into which is inserted a lead reservoir 5 accommodating one or more leads 4. To the front end of the lead reservoir 5, a chuck 6 for releasably gripping the lead 4 is connected. A chuck ring 7 is fitted on the outer periphery of the chuck 6 to control the opening and closing of the chuck, and the lead reservoir 5 is urged rearwardly by a compression spring 8. At the rear end of the lead reservoir 5 are attached an eraser 9 and an eraser cover 10. At the front end of the barrel 3, a tapered member 11 is threadedly attached. In the tapered member 11, an internal stepped portion 12 is formed and on which the chuck ring 7 abuts when the lead reservoir 5 is knocked, and a slider 14 having a lead-protecting pipe 13 is slidably disposed to undergo forward and backward movement. On the slider 14, a lead-holding portion 15 is provided to temporarily hold the lead 4 fed by a knocking operation.

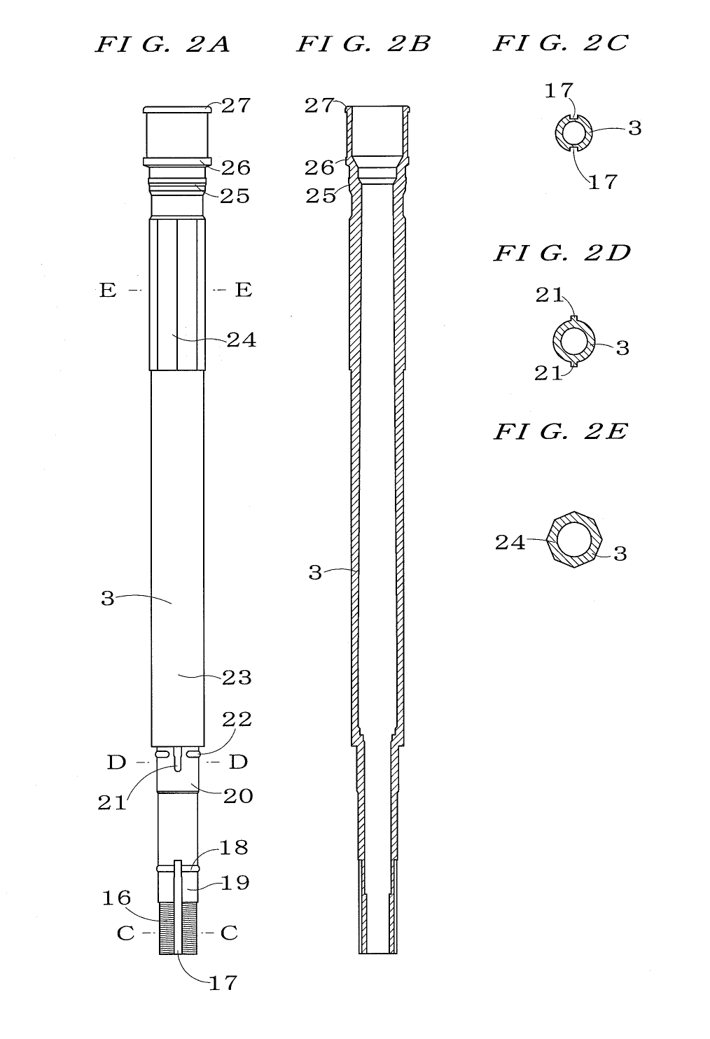

Referring to FIGS. 2A-2E, on the front outer periphery of the barrel 3 are provided an external thread 16 to threadedly attach the tapered member 11 and a small diameter part 19. The small diameter part 19 is provided with two front grooves 17 extending in an axial direction and a small annular projection 18. An intermediate diameter part 20 is connected to the small diameter part 19 and has a larger diameter than the small diameter part 19, and two intermediate projections (ribs) 21 extending in an axial direction and a small annular projection 22 are formed on the intermediate diameter part 20. A large diameter part 23 is connected to the rear of the intermediate diameter part 20 and at a part of the outer periphery of the large diameter part, an identification face 24 having a polygonal-shape, carving, printing, transfer, etc. is formed to detect the change when the barrel 3 rotates. At the rear end portion of the barrel 3, an annular guide rib 25 which inscribes in the main body cover 1 and a flange 26 which abuts on the rear end of the main body cover 1 are formed, and a rear end flange 27 is provided at a distance axially spaced from the internal flange 26.

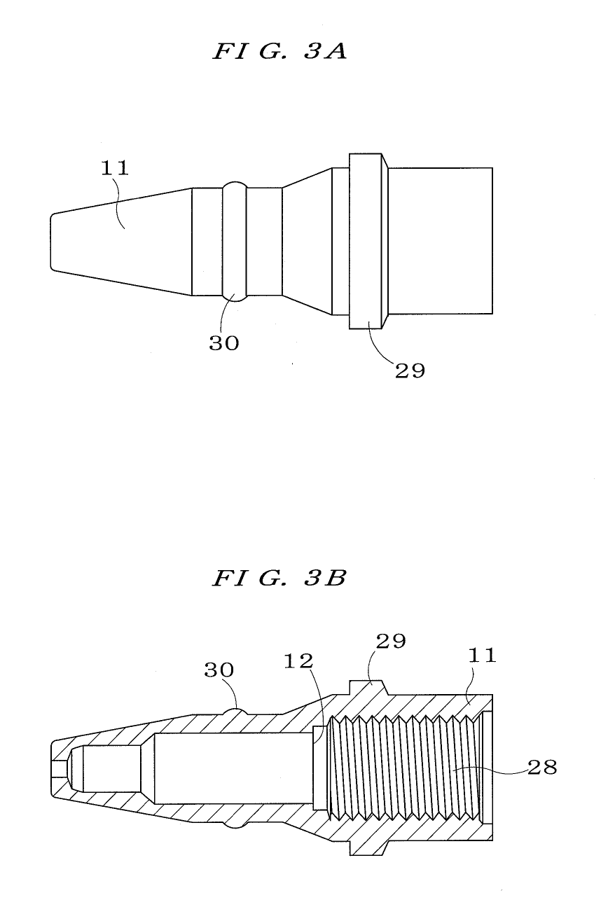

On the inner face of the tapered member 11, as shown in FIGS. 3A-3B, are formed an internal thread 28 that threadedly engages with the external thread 16 of the barrel 3, and the internal stepped portion 12 on which the chuck ring 7 abuts. The outer periphery of the tapered member 11 is tapered from the inward (rear) end side to the front end side, and at the inward end side is provided a circumferentially extending flange 29 which substantially inscribes in the front portion of the main body cover 1. At the front end side of the tapered member 11, frontward of the flange 29, an annular locking projection 30 in the form of an annular rib is formed axially spaced from the flange.

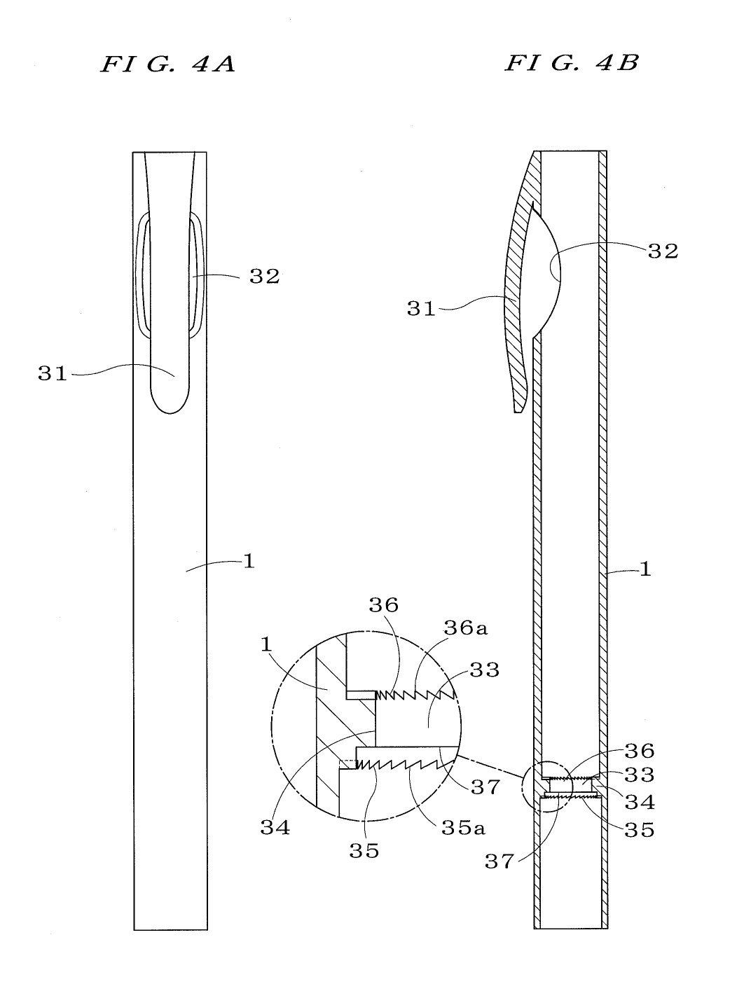

The main body cover 1 has, as shown in FIGS. 4A-4B, a tubular shape and is suitably configured and sized so that the main body 2 can be inserted therein to undergo forward and rearward axial movement as well as rotational movement. At the rear end of the main body cover 1, a clip 31 is provided, and beneath the clip, a window 32 is provided so that the identification face 24 of the pencil main body 2 housed therein is visible through the window. The window 32 may be formed at an appropriate position corresponding to the site on which the identification face 24 is provided. The window 32 shown in the example of this embodiment is formed by partially cutting away the main body cover 1. However, if the entire main body cover 1 or the window portion is made of a transparent material, no cut-away is needed.

According to this embodiment of the present invention, inside the main body cover 1, a crosswise partition 34 is formed, and the partition has a through-hole 33 through which the barrel 3 of the mechanical pencil main body 2 is inserted as shown in FIG. 1. At the forward face of the partition 34, a front gear 35 having forward teeth 35a is formed, and at the rear face of the partition, a rear gear 36 having rearward teeth 36a is formed. On the side face of the partition 34 at the front gear 35 side, a recessed receiver 37 (described later) is provided. The teeth 35a and 36a of the front gear 35 and the rear gear 36 are formed in a substantially herringbone shape having a straight face extending in an axial direction of the barrel and a diagonal face extending in a diagonal direction, and the phase of the teeth 35a is shifted or displaced relative to the teeth 36a so that the teeth 35a are out of phase with the teeth 36a.

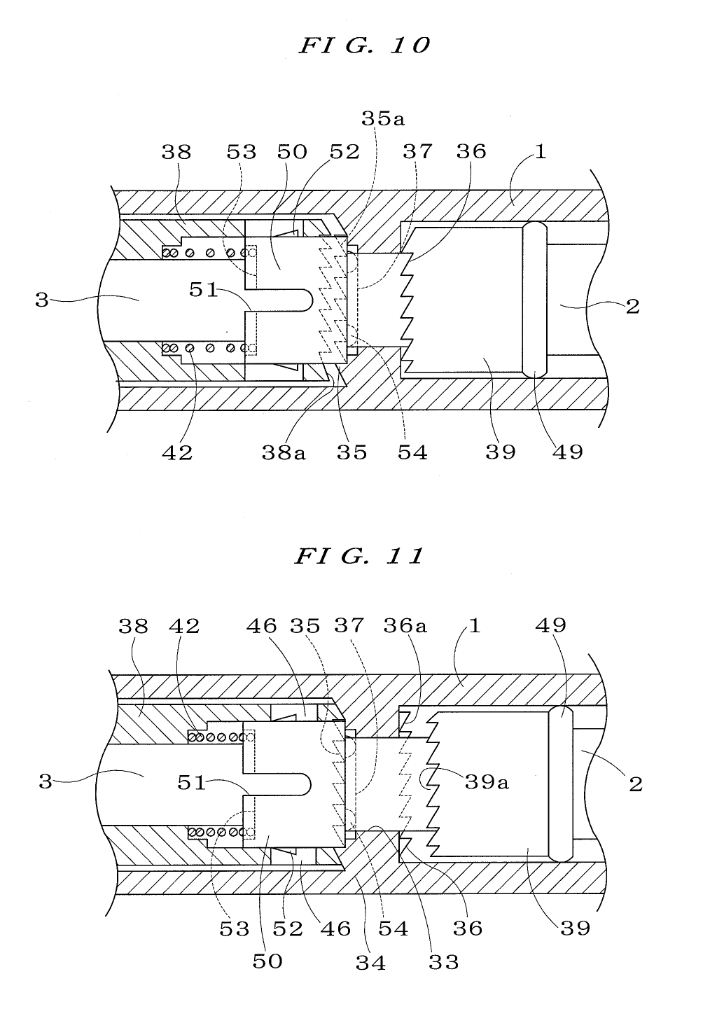

Fitted on the outer periphery of the barrel 3 of the main body 2 are a forward fixed gear 38 having teeth 38a configured to mesh with the front gear 35 of the main body cover 1 (FIG. 11) and a rearward fixed gear 39 having teeth 39a configured to mesh with the rear gear 36 (FIG. 10).

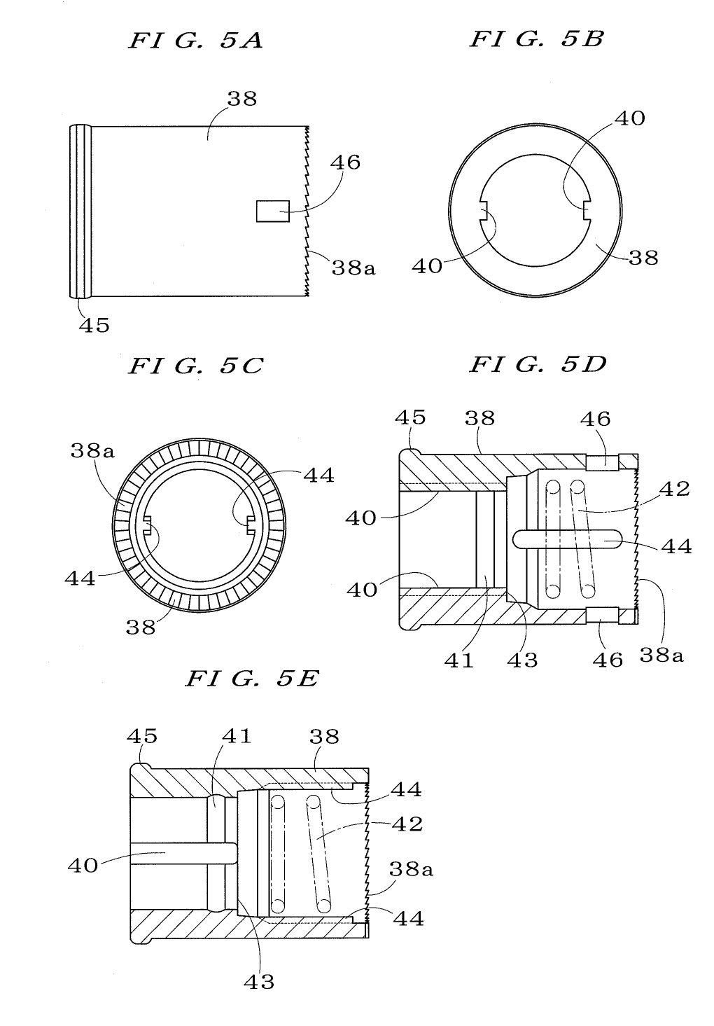

The forward fixed gear 38 is formed in a tubular shape, and as shown in FIGS. 5A-5E, the inner diameter of its front portion (left side in FIG. 5E) is formed so that it can be inserted onto the small diameter part 19 of the barrel 3. On the inside of the front portion are provided two opposed axial guide projections 40 that are inserted into the axial front grooves 17 of the barrel 3 and an annular recess 41 that is fitted onto the small annular projection 18. The inner diameter of the rear portion (right side in FIG. 5E) of the forward fixed gear 38 is formed larger than the inner diameter of the front portion so that it can accommodate a writing pressure spring 42 (described later). At the rear portion are provided an internal stepped part 43 which abuts on the stepped part between the small diameter part 19 and the intermediate diameter part 20 of the barrel 3 and holds one end of the writing pressure spring 42 (FIGS. 2 and 5E), and two axially extending rotation-preventing ribs 44. The gear teeth 38a are provided at the rear end face of the forward fixed gear 38 and are configured to engage with the front gear 35. Further, on the outer periphery of the front end part, an annular rib 45 which inscribes in the main body cover 1 is formed, and at the rear portion, a pair of opposed engagement holes 46 are provided.

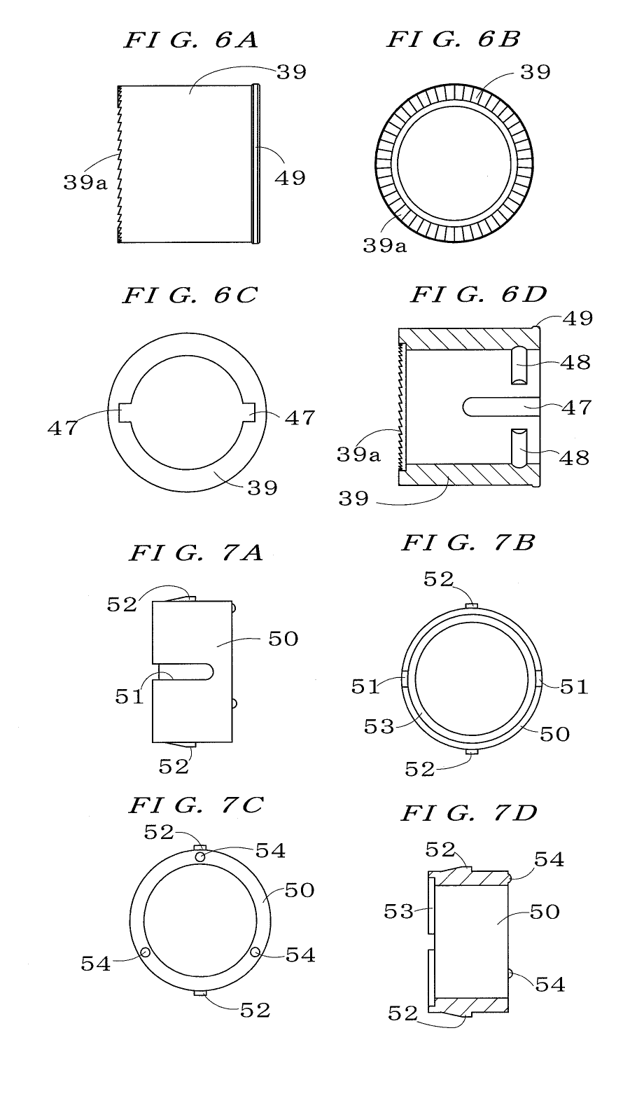

The rearward fixed gear 39 is, as shown in FIGS. 6A-6D, formed in a tubular shape and has an inner diameter dimensioned to be inserted onto the intermediate diameter part 20 of the barrel 3. On the inside of the rearward fixed gear 39 are provided two axially extending guide grooves 47 that engage with the intermediate projections 21 of the barrel 3 and an annular recess 48 in which fits the small annular projection 22 of the barrel 3. On the front end face of the rearward fixed gear 39 are formed gear teeth 39a configured to engage with the rear gear 36, and on the outer periphery of the rear portion (right side in FIG. 6D) is formed an annular rib 49 which inscribes in the main body cover 1.

The forward fixed gear 38 and the rearward fixed gear 39 may be integrally formed with the barrel 3. If the forward fixed gear 38 and the rearward fixed gear 39 are constituted by different parts from the barrel 3, the fixed gears 38, 39 may be made of a plastic material having a strength higher than that of the barrel 3, by which it becomes possible to obtain a durable mechanical pencil. As mentioned above, the shapes of respective teeth of the forward fixed gear 38 and the rearward fixed gear 39 are formed in a substantially herringbone shape so that they will mesh with the front gear 35 and the rear gear 36, respectively. Further, the phases of the teeth 35a are shifted with respect to the teeth 36a so that the pencil main body 2 can be incrementally rotated by meshing the forward fixed gear 38 and the rearward fixed gear 39 with the front gear 38 and the rear gear 39, alternately, by forward and backward motions of the main body 2.

The writing pressure spring 42 inserted into the rear end portion of the forward fixed gear 38 is incorporated so that it may rotate with the forward fixed gear in this embodiment. The rear end of the writing pressure spring 42 abuts on a slide ring 50, and the slide ring 50 is held by the receiver 37 provided at the partition 34 of the main body cover 1. The slide ring 50 is, as shown in FIGS. 7A-7D, formed in a tubular shape and inserted into the rear portion of the forward fixed gear 38 as shown in FIG. 1. On the outer periphery of the slide ring 50 are formed two axial rotation-preventing grooves 51 which engage with respective ones of the rotation-preventing ribs 44 provided on the forward fixed gear 38, and two opposed locking projections 52 which engage with respective ones of the engagement holes 46 of the forward fixed gear 38. At the forward side of the slide ring 50 which is inserted into the forward fixed gear 38, a spring receiver 53 which receives the writing pressure spring 42 is formed, and at the rearward side thereof, three slidable contact projections 54 protruding in a substantially spherical shape are provided to make substantially point-contact with the receiver 37 of the main body cover 1.

The writing pressure spring may also be incorporated in a way that it does not rotate together with the forward fixed gear. In this instance, a slide ring is provided between the internal stepped part of the forward fixed gear and the front end of the writing pressure spring, and the rear end of the writing pressure spring is allowed to abut on the partition of the main body cover, whereby when the forward fixed gear is rotated, slippage occurs between the forward fixed gear and the slide ring.

In the embodiment shown in FIG. 1, when the main body 2 is inserted into the main body cover 1, the tapered member 11 and the rear end of the barrel 3 of the pencil main body protrude from the main body cover and are exposed. The exposed portions are covered with rotatable protection collars 55. In this embodiment, the protection collar 55 are constituted by a tapered collar 56 rotatably attached to the tapered member 11 and a main body collar 57 rotatably attached to the rear end of the barrel 3.

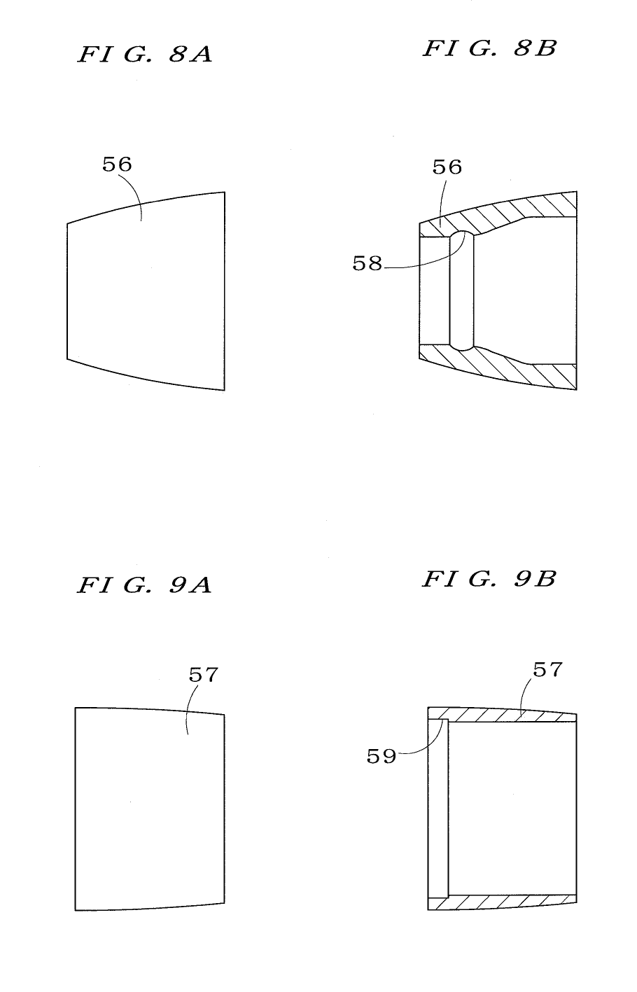

As shown in FIGS. 8A-8B, the rear end of the tapered collar 56, which contacts the internal flange 29 of the tapered member as shown in FIG. 1, is formed to have substantially the same inner diameter as the inner diameter of the front end part of the main body cover 1, and the front end of the tapered collar 56 is formed in a tubular shape with a diameter smaller than the rear end. Inside the tapered collar 56, an engagement groove 58 is provided that rotatably engages with the engagement projection 30 of the tapered member 11.

In the main body collar 57, as shown in FIGS. 9A-9B, the rear end side is formed in a substantially tubular shape with a diameter smaller than that of the front end side, and the main body collar 57 is sandwiched between the internal flange 26 and the rear end flange 27 of the barrel 3. At the front end side, a recess 59 is formed that rotatably engages with the internal flange 26.

In order to incorporate the main body 2 into the main body cover 1, the rearward fixed gear 39 is attached to the barrel 3 and then the mechanical pencil main body 2 is inserted from the rear portion of the main body cover 1. Through the through-hole 33 of the partition 34 of the main body cover 1, the main body 2 is inserted, and the forward fixed gear 38 having the writing pressure spring 42 and slide ring 50 incorporated is attached to the front part of the barrel 3 from the front portion of the main body cover 1. The tapered member 11 is threadedly attached to the barrel 3 to prevent detachment of the forward fixed gear 38. Then the tapered collar 56 is attached to the outer periphery of the tapered member 11 and the main body collar 57 is attached to the rear end of the barrel 3.

By the above structure, when no writing pressure is applied, since the main body 2 is urged forward by the writing pressure spring 42 as shown in FIG. 10, the rearward fixed gear 39 and the rear gear 36 are engaged. When writing pressure is applied, the main body 2 retracts against the writing pressure spring 42, and as shown in FIG. 11, the rearward fixed gear 39 is disengaged from the rear gear 36 and the forward fixed gear 38 is engaged with the front gear 35. When writing pressure is no longer applied, the main body 2 advances by the action of the writing pressure spring 42, and therefore the forward fixed gear 38 is disengaged from the front gear 35 and the rearward fixed gear 39 is engaged with the rear gear 36.

More particularly, during rearward movement or retraction of the main body 2 from the position illustrated in FIG. 10 to the position illustrated in FIG. 11, the apexes of the gear teeth 38a of the forward fixed gear 38 engage with and slide along the diagonal faces of the gear teeth 35a of the front gear 35 thereby incrementally rotating the main body 2 in one direction (downward in FIGS. 10-11). At the same time, rearward movement of the main body 2 disengages the rearward fixed gear 39 from the rear gear 36. During forward movement or advancement of the main body 2 from the position illustrated in FIG. 11 to the position illustrated in FIG. 10, the apexes of the gear teeth 39a of the rearward fixed gear 39 engage with and slide along the diagonal faces of the gear teeth 36a of the rear gear 36 thereby incrementally rotating the main body 2 in the one direction (downward in FIGS. 10-11). At the same time, forward movement of the main body 2 disengages the forward fixed gear 38 from the front gear 35. In this manner, the main body 2 incrementally rotates in the same direction in response to forward and rearward axial movement of the main body.

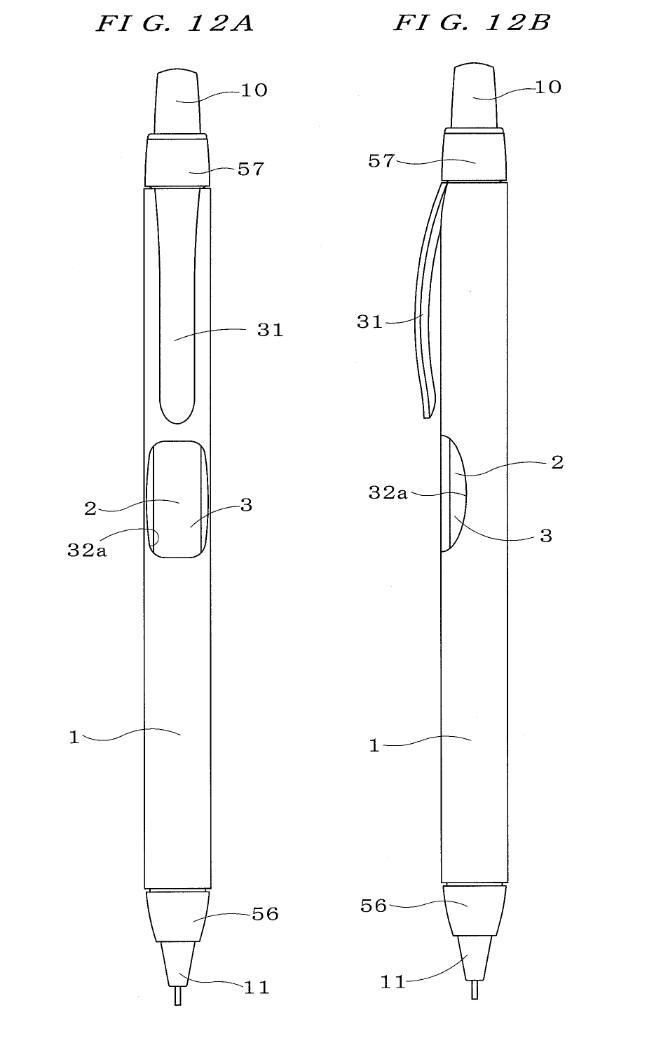

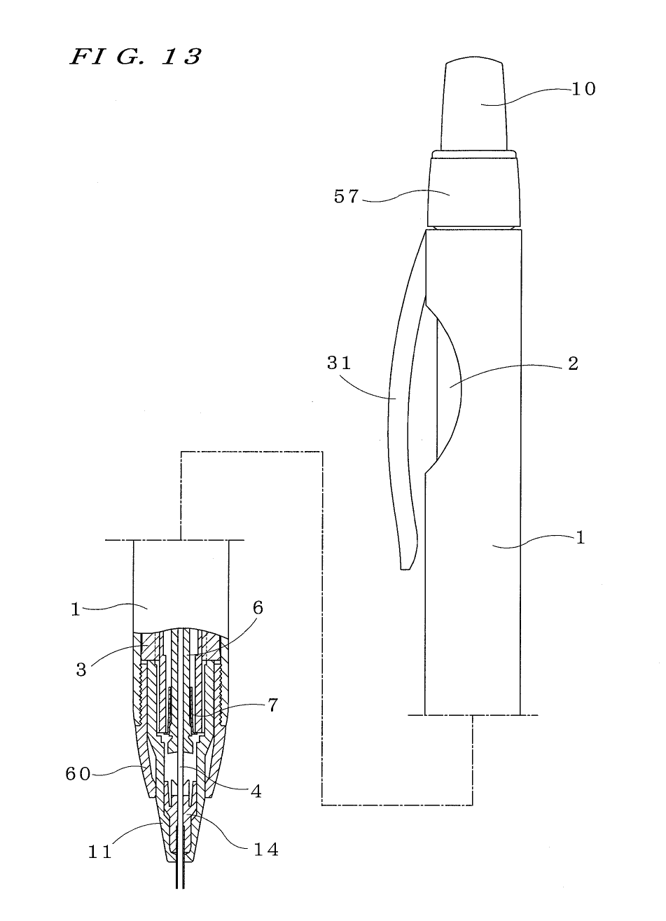

In the engagement and disengagement of the gears, since the phase of the teeth of the forward fixed gear 38 and the front gear 35 is displaced relative to the phase of the teeth of the rearward fixed gear 39 and the rear gear 36, the main body 2 having the forward fixed gear 38 and the rearward fixed gear 39 rotates incrementally, and as a result, the lead 4 rotates. When the main body 2 rotates, since the main body cover 1 does not rotate, the slidable contact projections 54 of the slide ring 50 supporting one end of the writing pressure spring 42 slide on the surface of the receiver 37 of the main body cover 1. Since the frictional resistance generated at this time is smaller than the case where the writing pressure spring 42 is directly supported by the receiver 37 of the main body cover 1, the main body 2 smoothly rotates together with the forward and rearward motions of the main body 2, and the lead 4 is securely rotated. Rotation of the main body 2 can be seen via the window 32 provided beneath the clip as shown in FIG. 1 and FIG. 4 or through the window 32a provided at the intermediate portion of the main body cover as shown in FIG. 12.

As mentioned above, in the mechanical pencil according to the present invention, the outer face of the mechanical pencil main body 2 exposed from the main body cover 1 is covered with one or more rotatable protection collars 55 and in this embodiment, the exposed portions of the main body 2 at the front and rear portions of the main body cover 1 are covered with the tapered collar 56 and the main body collar 57. Accordingly, even if a person tries to rotate the mechanical pencil main body 2 by gripping the protection collars, these collars idle and the mechanical pencil main body does not rotate, and therefore it becomes possible to avoid damage to the gear mechanism. The main body cover 1 and the barrel 3 of the mechanical pencil main body 2 can be constructed in an appropriate length, size, shape, etc., so that the part or parts of the mechanical pencil main body 2 exposed from the main body cover 1 can be changed as desired. In such instance, depending on the location of the exposed part or parts, the number and shape of the protection collars can be appropriately selected.

For example, as shown in the embodiment of FIG. 13, at the front end of the main body cover 1, when a front end cover 60 is threadedly attached and fixed to cover the major part of the tapered member 11, the tapered collar 56 can be omitted.

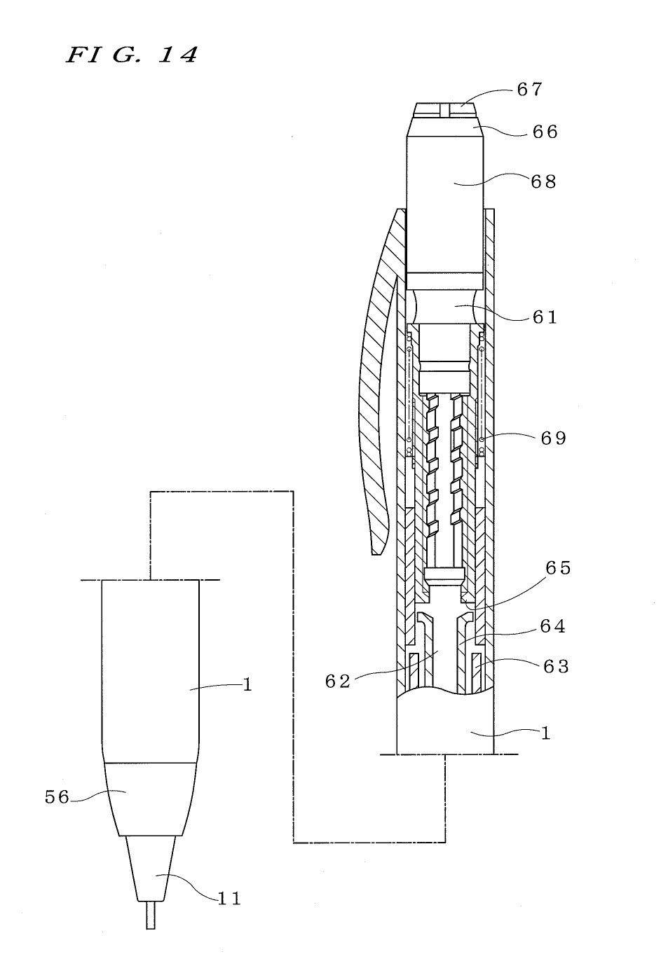

In another example shown in the embodiment of FIG. 14, a conventional detachable feeding-type eraser unit 61 may be provided at the rear end of the main body cover 1. In this instance, the rear end of a pencil main body 62 is hidden in the main body cover 1, and the rear end of a lead reservoir 64 protrudes backwardly from a barrel 63 and faces an internal end 65 of the feeding-type eraser unit 61. Accordingly, the rear end of the pencil main body 62 is not exposed outwardly, and therefore the above main body collar 57 is no longer needed. Since the structure of the feeding-type eraser unit 61 is widely known, a detailed explanation thereof is omitted. However, briefly explaining, an eraser 67 can be extended from or retracted into the rear end by rotating a rotation unit 66. When a knock cover 68 is knocked against a return spring 69, the unit advances as a whole, and the internal end 65 abuts on the lead reservoir 64 and makes the lead reservoir advance thereby advancing the lead.

It will be appreciated by those skilled in the art that obvious changes can be made to the examples and embodiments described in the foregoing description without departing from the broad inventive concept thereof. It is understood, therefore, that this disclosure is not limited to the particular examples and embodiments disclosed, but is intended to cover all obvious modifications thereof which are within the scope and the spirit of the disclosure as defined by the appended claims.

What is claimed is:

1. A mechanical pencil comprising: a tubular main body cover having on the inside thereof axially spaced apart front and rear gears; a main body that is housed in the main body cover to undergo forward and rearward axial movement and rotational movement and that feeds a lead from a front end thereof, the main body having one or more exposed peripheral surface portions that are exposed and not covered by the main body cover; a forward fixed gear fixed to the main body forward of the front gear and a rearward fixed gear fixed to the main body rearward of the rear gear, the forward fixed gear being disengageable from and engageable with the front gear and the rearward fixed gear being engageable with and disengageable from the rear gear in response to forward and rearward axial movement of the main body to incrementally rotate the main body thereby incrementally rotating the lead; a writing pressure spring that moves the main body axially forward when no writing pressure is applied to the lead and that allows the main body to move axially rearward when writing pressure is applied to the lead; and one or more protection collars each rotatably disposed on the main body and covering one of the exposed peripheral surface portions thereby preventing a person from gripping the exposed peripheral surface portion and rotating the main body.

2. A mechanical pencil according to claim 1; wherein one exposed peripheral surface portion comprises a rear end portion of the main body that protrudes rearward from the rear end of the main body cover, and one protection collar is rotatably mounted to and covers the protruding rear end portion of the main body.

3. A mechanical pencil according to claim 2; wherein the rear end portion of the main body has two axially spaced annular flanges, and the one protection collar is rotatably confined between the two annular flanges.

4. A mechanical pencil according to claim 2; wherein another exposed peripheral surface portion comprises a front end portion of the main body that protrudes frontward from the front end of the main body cover, and another protection collar is rotatably mounted to and covers the protruding front end portion of the main body.

5. A mechanical pencil according to claim 4; wherein the main body has a tip member that constitutes the protruding front end portion and through which the lead is fed, and the other protection collar is rotatably mounted to the tip member.

6. A mechanical pencil according to claim 1; wherein the writing pressure spring is provided between the main body cover and the forward fixed gear, and one end of the writing pressure spring is supported by the main body cover or the forward fixed gear via a rotatable slide ring.

7. A mechanical pencil according to claim 6; wherein the slide ring is axially slidably inserted into a rear portion of the forward fixed gear, rotates with the forward fixed gear, and has at its rearward side slidable contact projections that slidingly contact a receiver surface of the main body cover when the main body rotates.

8. A mechanical pencil according to claim 7; wherein the writing pressure spring is interposed between the forward fixed gear and the slide ring.

9. A mechanical pencil according to claim 7; wherein the forward fixed gear has engagement holes, and the slide ring has locking projections slidably engaged in respective ones of the engagement holes so that the slide ring rotates with the forward fixed gear and is axially slidable in the forward fixed gear.

10. A mechanical pencil according to claim 9; wherein the writing pressure spring is interposed between the forward fixed gear and the slide ring.

11. A mechanical pencil according to claim 6; wherein one exposed peripheral surface portion comprises a rear end portion of the main body that protrudes rearward from the rear end of the main body cover, and one protection collar is rotatably mounted to and covers the protruding rear end portion of the main body.

12. A mechanical pencil according to claim 11; wherein the rear end portion of the main body has two axially spaced annular flanges, and the one protection collar is rotatably confined between the two annular flanges.

13. A mechanical pencil according to claim 11; wherein another exposed peripheral surface portion comprises a front end portion of the main body that protrudes frontward from the front end of the main body cover, and another protection collar is rotatably mounted to and covers the protruding front end portion of the main body.

14. A mechanical pencil according to claim 13; wherein the main body has a tip member that constitutes the protruding front end portion and through which the lead is fed, and the other protection collar is rotatably mounted to the tip member.

15. A mechanical pencil according to claim 6; wherein the main body cover has a window through which the rotation condition of the main body can be seen from the outside.

16. A mechanical pencil according to claim 1; wherein the main body cover has a window through which the rotation condition of the main body can be seen from the outside.
